(19) United States
(12) Patent Application Publication
(10) Pub. No.: US 2024/0338658 A1
(43) Pub. Date: Oct. 10, 2024

(54) LINKING ITEMS TO DIGITAL SHELF LABELS USING MODULAR IMAGE DATA

(71) Applicant: Walmart Apollo, LLC, Bentonville, AR (US)

(72) Inventors: Jeremy L. Velten, Bella Vista, AR (US); Binoy Yonzon, New Providence, NJ (US); Gina Smith, Fayetteville, AR (US); Jason Harbison, Rogers, AR (US)

(21) Appl. No.: 18/625,459

(22) Filed: Apr. 3, 2024

Related U.S. Application Data
(60) Provisional application No. 63/494,773, filed on Apr. 7, 2023.

(51) Int. Cl. G06Q 10/0875; G06F 16/587

(52) U.S. Cl. CPC G06Q 10/0875; G06F 16/587

(57) ABSTRACT

Examples provide a tag manager for linking digital tags to assigned items on a modular display using image data of the modular display. The image data is analyzed to identify the number of digital tags on the modular display and the current location of each digital tag. If any digital tags are not located in an expected location, the tag manager generates customized instructions for changing a placement of the digital tags to correspond to expected locations for the digital tag, including removing excess digital tags, adding missing digital tags and/or moving digital tags which are currently placed outside the threshold range from the tag's assigned location. If the number of digital tags is the expected number of tags and all the digital tags are placed within a threshold range of an assigned tag location, the digital tags are linked to items assigned to the display using modular data.

### BACKGROUND

In a retail environment, products offered for sale, order, rental or otherwise displayed for viewing by customers are frequently accompanied by a digital shelf label (DSL) tag attached to shelving or another portion of a product display. The digital tag typically displays information associated with the product, such as, but not limited to, name of the product, brand, variety, pricing information, package size, item count, and/or other information. However, these digital tags can be difficult and cumbersome to program. Moreover, when changes are made to product information, such as price changes, the digital tags associated with the products are generally replaced or manually re-programmed one at a time to reset the tag to display the new information in a process which can be slow, time-consuming, and expensive for some users.

### SUMMARY

Some examples provide a system for linking digital tags using modular data. A plurality of digital tags attach to a portion of a modular display. Each tag in the plurality of digital tags display a tag unique identifier (UID) on a tag display of each digital tag. An image of the portion of the modular display is obtained. The image includes a plurality of tag UIDS displayed by each digital tag in the plurality of digital tags. A plurality of current tag locations for digital tags on the modular display is identified in the image of the portion of the modular display using the tag UIDs. A determination is made the plurality of current tag locations of the plurality of digital tags correlate with a plurality of assigned tag locations in modular data associated with the modular display. The plurality of digital tags is linked with a plurality of different item types assigned to the modular display in response to the plurality of current tag locations correlating with the plurality of assigned tag locations. A digital tag linked to a selected item type is populated with item data describing the selected item type. A customized instruction to alter a location of at least one digital tag in the plurality of digital tags is generated in response to the plurality of current tag locations failing to correlate with the plurality of assigned tag locations. The customized instruction is presented to a user via a user interface device.

Other examples provide a method for linking digital tags using modular data. Image data associated with an image of a portion of the modular display is received from an image capture device. The image includes a plurality of tag UIDS associated with a plurality of digital tags associated with the portion of the modular display. A plurality of current tag locations of the plurality of digital tags is identified from the image using the plurality of tag UIDs in the image data. Each digital tag in the plurality of digital tags is associated with a current tag location on the modular display. A determination is made whether the plurality of current tag locations of the plurality of digital tags correlates with a plurality of assigned tag locations associated with the modular display. An assigned tag location is associated with each item or item type in a plurality of items assigned to the portion of the modular display. The plurality of digital tags is linked to a plurality of item UIDs associated with a plurality of items assigned to the portion of the modular display in response to every current tag location in the plurality of current tag locations correlating with an assigned tag location in the plurality of assigned tag locations. Each linked digital tag in the plurality of digital tags is populated with the item data describing a type of item associated with an item UID in the plurality of item UIDs. A customized instruction for changing a current location of at least one digital tag in the plurality of digital tags is generated in response to a failure to correlate every current tag location in the plurality of current tag locations with an assigned tag location in the plurality of assigned tag locations. The customized instruction is presented to a user via a user interface device.

Still other examples provide a computer storage device having computer-executable instructions stored thereon, which, upon execution by a computer, cause the computer to perform operations for linking digital tags using modular data. A plurality of current tag locations of the plurality of digital tags is identified from image data associated with an image of a portion of the modular display. The image includes a plurality of tag UIDS associated with the plurality of digital tags. Each tag location in the plurality of current tag locations is correlated with each assigned tag location in a plurality of assigned tag locations associated with modular data associated with the portion of the modular display to form a set of correlated digital tags. A set of tag UIDs associated with the set of correlated digital tags is linked with a set of item UIDs associated with a plurality of items assigned to the modular display. A digital tag in the set of correlated digital tags linked to an item UID is populated with item data describing the item type associated with the item UID linked to the digital tag. A customized instruction to alter a location of each digital tag in the plurality of digital tags failing to correlate with the plurality of assigned tag locations is generated. The customized instruction is presented to a user via a user interface device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for linking item data to digital tags using modular data.

FIG. 2 is an exemplary block diagram illustrating a modular display associated with a plurality of digital tags.

FIG. 3 is an exemplary block diagram illustrating a portion of a modular display including a plurality of digital tags removably attached to the modular display.

FIG. 4 is an exemplary block diagram illustrating a planogram representing a portion of a modular display including a plurality of assigned tag locations associated with an expected number of digital tags.

FIG. 5 is an exemplary block diagram illustrating modular data associated with a portion of a modular display.

FIG. 6 is an exemplary block diagram illustrating image data associated with a portion of a modular display.

FIG. 7 is an exemplary flow chart illustrating operation of the computing device to generate alert notifications associated with placement of digital tags on a portion of a modular display.

FIG. 8 is an exemplary flow chart illustrating operation of the computing device to generate customized instructions for correcting erroneous tag placements on a modular display.

FIG. 9 is an exemplary flow chart illustrating operation of the computing device to link digital tags with items assigned to a modular display using image data.

FIG. 10 is an exemplary flow chart illustrating operation of the computing device to display customized instructions to users associated with changing a location of digital tags to correlate with expected digital tag locations.

FIG. 11 is an exemplary diagram illustrating a user interface (UI) displaying an initial status page for setting a modular having a plurality of sections.

FIG. 12 is an exemplary diagram illustrating a UI displaying a plurality of departments including a plurality of modular displays.

FIG. 13 is an exemplary diagram illustrating a UI displaying a plurality of items assigned to a plurality of modular displays associated with a given department in a retail environment.

FIG. 14 is an exemplary diagram illustrating a UI displaying a plurality of items assigned to a set of modular displays in a retail environment.

FIG. 15 is an exemplary diagram illustrating a UI displaying a landing page for setting a section of a modular display in a plurality of modular displays ready to be set.

FIG. 16 is an exemplary diagram illustrating a UI displaying a scan aisle location instruction for setting digital tags on the portion of the modular display associated with the aisle location.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable linking digital tags to items assigned to a modular display using image data and modular data associated with the modular display. In some examples, a tag manager analyzes an image of a modular display to identify a current location of a plurality of digital tags removably attached to the modular display. In this manner, multiple digital tags can be identified at once using a single image of the modular display without requiring a user to scan each individual digital tag and each item being linked to the digital tag. This reduces processor and memory usage consumed during scanning of individual digital tags and item unique identifier (UID) during setting of modular displays. A UID can include, for example, a barcode, quick response (QR) code, radio frequency identifier (RFID) tag, serial number, or any other identifier.

Aspects of the disclosure further enable automatic generation of instructions for correcting misplaced digital tags on the modular display. In some examples, the tag manager generates customized instructions to assist a user in correcting the placement of digital tags that have been placed outside an acceptable threshold range from the assigned location of the digital tags. Thus, if a digital tag is placed at or near the assigned location, the digital tag is linked to an item. However, if the digital tag is located too far away from the assigned position of the digital tag, the tag manager generates customized instructions identifying the erroneously placed digital tag with instructions on how to correct the placement. This improves user efficiency via interaction with the UI as well as increasing user interaction performance.

In some examples, the tag manager utilizes one or more images of the modular display to identify placement of digital tags and link the tags to items on the modular display. This enables populating of multiple tags simultaneously without scanning each individual digital tag manually for reduced memory usage storing a single image rather than storing scan data for each of the plurality of digital tags and each of the plurality of items.

In still other examples, the tag manager analyzes image data to determine if a digital tag is missing. In response, the tag manager generates customized instructions identifying the assigned location of the missing digital tag and instructions for the user to place a digital tag in the initial state onto the modular display. This enable reduced error rates and reduces network bandwidth usage which would result if missing digital tags went undetected and/or unreplaced.

Other aspects enable a tag manager that identifies and eliminates digital tags erroneously placed on a modular display. Preventing placement of excess digital tags on the modular display and/or ensuring incorrectly placed digital tags are removed reduces processor load caused by attempts to communicate with incorrectly placed digital tags and digital tag controllers.

In yet other examples, the tag manager analyzes image data to detect digital tags erroneously placed on a modular display. The tag manager generates customized instructions identifying the digital tag which does not belong on the modular display with instructions for the digital tag to be removed. This further reduces the error rate and minimize network bandwidth usage which would otherwise be expended in attempts to communicate with digital tags linked to the incorrect items or placed in the wrong location.

The computing device operates in an unconventional manner by automatically identifying the locations of digital tags in an unlinked state on a modular display using image(s) of the modular display and planogram data assigning the digital tags to locations on the modular display while providing customized instructions to correct and/or avoid errors resulting from incorrectly placed digital tags in real-time as the modular is being set. In this manner, the tag manager allows faster and more efficient linking of digital tags with item data while eliminating erroneously placed digital tags.

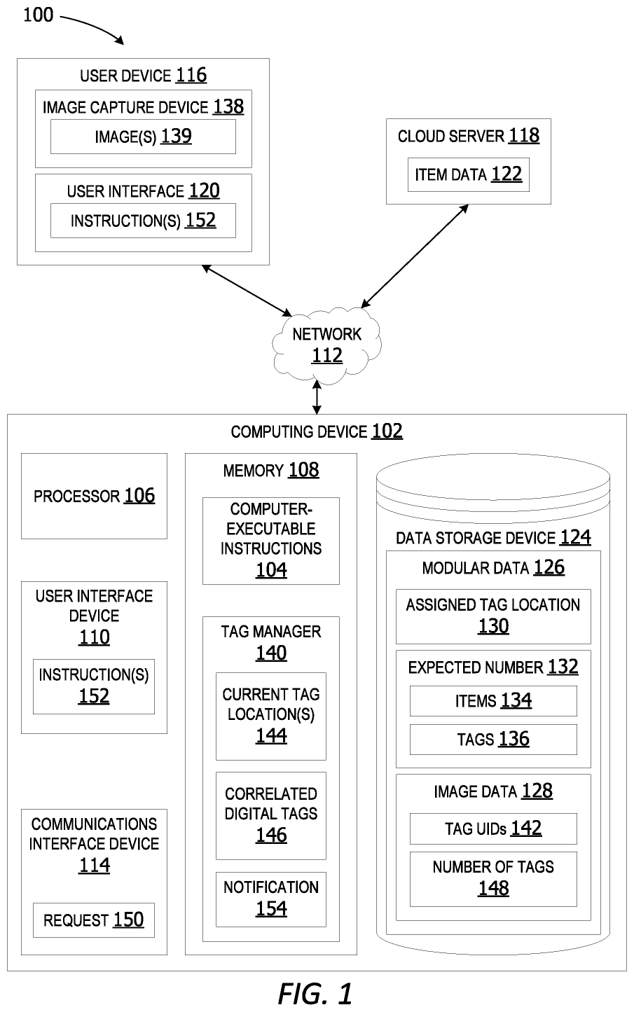

Referring again to FIG. 1, an exemplary block diagram illustrates a system 100 for linking item data to digital tags using modular data. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

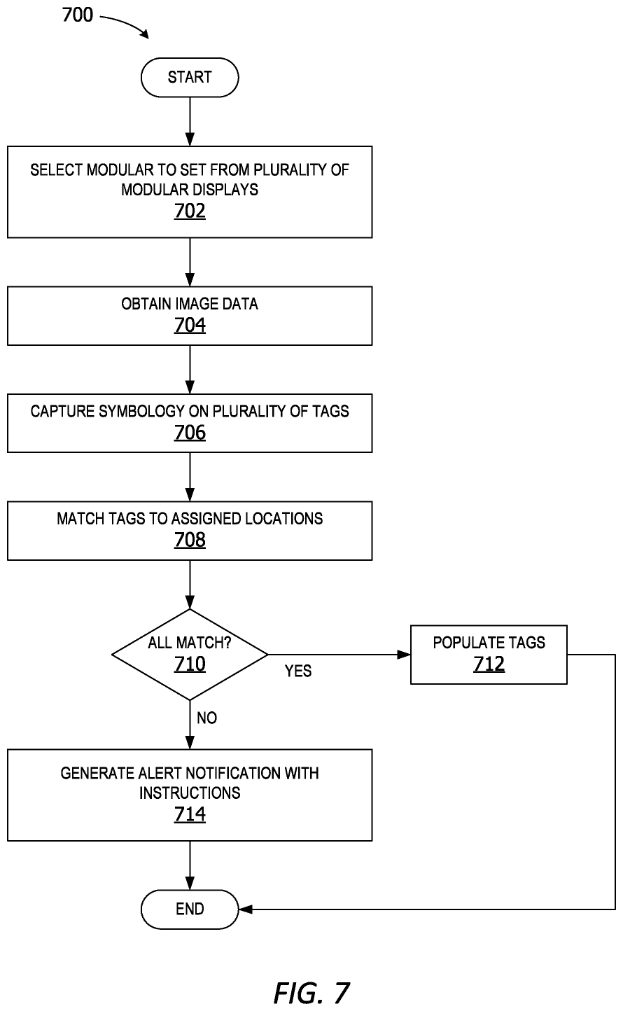

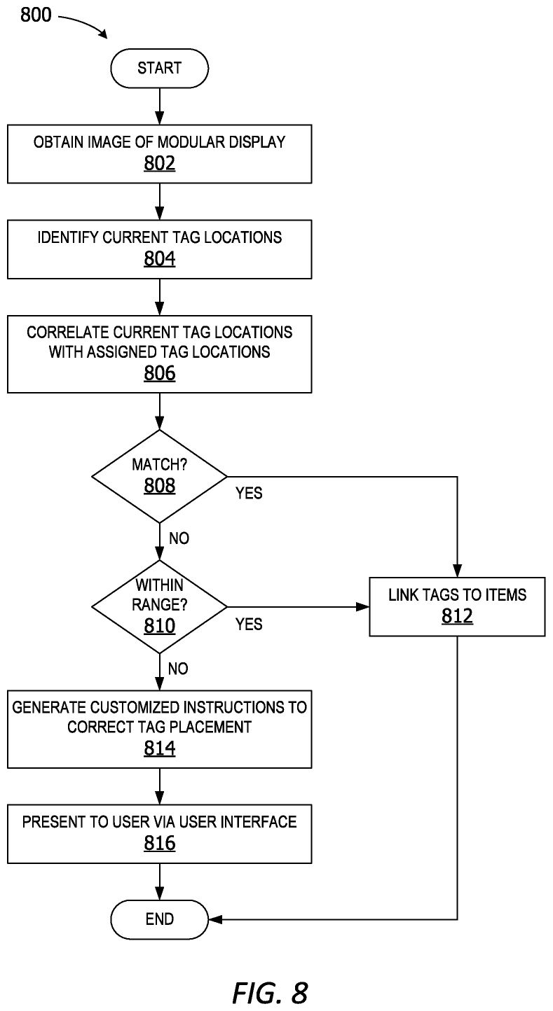

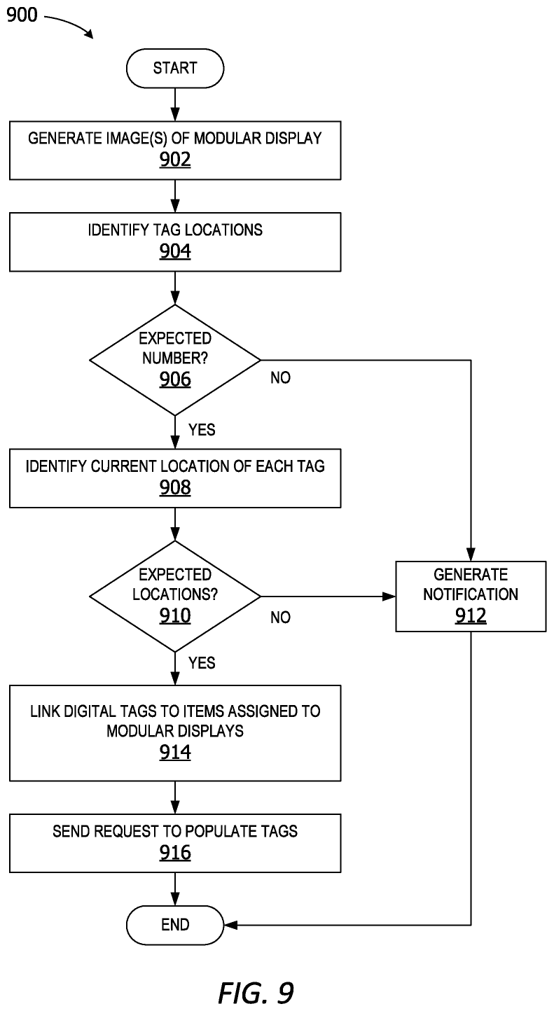

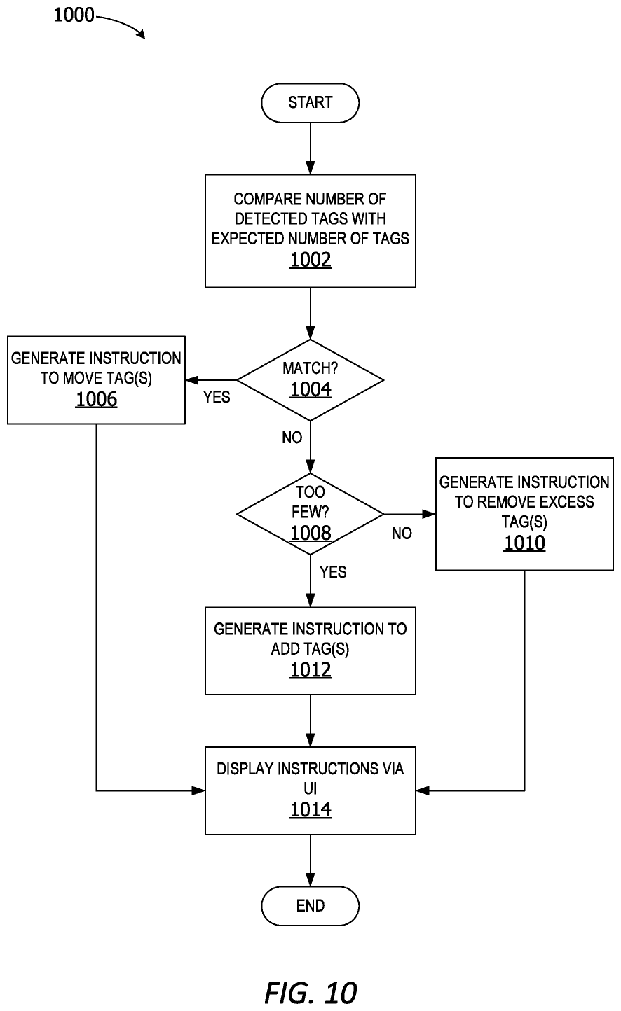

The processor 106 includes any quantity of processing units and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 7, FIG. 8, FIG. 9, and FIG. 10).

The computing device 102 further has one or more computer-readable media such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown).

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI), such as, but not limited to, a user interface 120.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The cloud server 118 in other examples, can include a cloud storage. In other examples, the cloud server 118 has access to a cloud storage via the network 112. The cloud server 118 and/or a cloud storage optionally stores data utilized by the system 100, such as, but not limited to, item data 122. The item data 122 is data describing an item assigned to be displayed on a modular display and/or a portion of a modular display.

A modular display is a display or portion of a display for displaying one or more different types of items and/or instances of one or more different types of items within a retail environment. The modular display is implemented as any type of display, such as, but not limited to, a shelf, a set of shelves, a cabinet, a temperature-controlled display, an end-cap display, a rack, a set of racks, a set of hooks or pegs for hanging items on, a gondola shelf, wall-mounted shelf, bin, aisle display, rotating display, or any other type of display. A temperature-controlled display includes refrigerated displays, freezer displays, warmer areas, and/or heated displays.

In this example, the item data 122 is data describing items assigned to a modular display or portion of a modular display within a retail environment. The retail environment is an environment in which items are displayed or made available to customers for sale/purchase, lease/rental, or viewing. The retail environment can include an indoor (enclosed) area, an outdoor (unenclosed) area, and/or a partially enclosed area. For example, the retail environment can include the items within a store, the items displayed in an outside area adjacent to the store, and/or an area in a partially enclosed area, such as a garden center. A retail environment can include, in some examples, a grocery store, sporting goods store, garden center, a sales floor, an outdoor area associated with a sidewalk sale, or any other retail area.

The system 100 can optionally include a data storage device 124 for storing data, such as, but not limited to modular data 126 and/or image data 128. The modular data 126 is data associated with one or more modular displays. The modular data 126 includes data describing a plurality of items assigned to be displayed on or within a given modular display and/or an assigned tag location 130 for each digital tag in a plurality of digital tags assigned to be placed on the modular display. The modular data 126 in some examples includes a planogram. The plurality of items can include one or more different types of items, one or more instances of one or more different types of items and/or one or more instances of the same type of item.

The assigned tag location 130 of a given digital tag is the assigned place or location on the modular display in which the given digital tag should be placed or position. In some examples, the assigned tag location 130 is a notch number or number of notches or other distance indicators on the modular display. For example, a digital tag which is to be placed on a top shelf at the right-hand side may be assigned a location that is five notches to the right of the edge of the top shelf. In other examples, the assigned tag location 130 is a distance measurement, such as three inches along a rail or bracket supporting the digital tags on the modular display. In still other examples, the assigned tag location 130 includes a minimum threshold range of an assigned location of an item that is placed on the modular display or assigned to be placed on the modular display when the modular display is stocked in accordance with the planogram. However, the examples are not limited to notches, measurements, or range values. Any method for identifying an assigned location may be implemented in other examples.

In other examples, the modular data includes an expected number 132 of items 134 assigned to be displayed on the modular display and/or the expected number 132 of digital tags 136 assigned to be placed on the modular display or portion of the modular display. The expected number of items 134 is a number of different types of items assigned to the modular display rather than the number of instances of each item type to be stocked on the modular display.

Different types of items can include different categories of items, different brands of the same category of item, different varieties of the same brand, different sizes or counts per package of an item, etc. A category of an item can include a bread category and a condiments category. A different variety can include a spicy variety and a mild variety of the same item. For example, if ten different types of pickles are assigned to the modular display, there are ten different expected items even if the total number of jars of pickles stocked on the modular display includes a dozen instances of each type of pickles.

In this example, the expected number of digital tags 136 is equal to the expected number of items 134. In other words, if there are ten different varieties of pickles assigned to the modular display, the expected number of digital tags assigned to the display also equals ten tags, such that one digital tag displays item data 122 for each of the different varieties of pickles.

In other examples, the expected number of tags can exceed the expected number of items 134, such as where multiple digital tags display item data for a single type of item. For example, if a large number of instances of one type of item, such as fifty pound bags of dog food, is assigned to be displayed across a large area of a shelf on a modular, it may be desirable to include two or more digital tags displaying the same item data for that single item attached to the shelf at different locations across that large area to make it easier for customers to locate the item information for the item.

In still other examples, the expected number of items may be larger than the expected number of tags where a single digital tag can be populated with item data which corresponds to two or more different types of items. Thus, in one example, a digital tag may include the price information for two different varieties of the same brand of ketchup having the same size information, price information and brand information.

The image data 128 is data associated with one or more images of a modular display or portion of a modular display. The image data 128 is generated by an image capture device, such as, but not limited to, the image capture device 138. The image capture device 138 is implemented as any type of image capture device generating image(s) 139, such as, but not limited to, a camera.

The image capture device 138 in this example includes one or more digital cameras incorporated within the user device 116. However, the examples are not limited to a camera in a user device. The image capture device may be any type of known or available imaging device, including a black-and-white camera, color camera, digital camera, analog camera, rotatable camera, stationary camera, mobile camera mounted on a robotic device or drone, a camera associated with a mobile user device, or any other image capture device. The image capture device may generate still images or a series of images in a video.

In some examples, the image capture device is permanently mounted. In other examples, the image capture device is moveably mounted such that the image capture device may be moved or relocated to a non-permanent position. The image capture device may include a color scale or gray scale. The image capture device may optionally be set up with the color scale or gray scale to optimize the images generated by the image capture device.

In some examples, the image capture device optionally includes a camera mounted to a ceiling, pole, modular display, or other fixture. The image capture device can optionally also include one or more cameras integrated within a mobile robotic device capable of generating images of a modular display autonomously and transmitting the image data to the computing device 102 via the network 112. In other examples, the image capture device includes a security camera. The image generated by the image capture device includes one or more tag UIDs. In other words, the tag UIDs displayed on the tag display of one or more digital tags is visible in the image or images generated by the image capture device. The tag display on each digital tag is a display screen on the digital tag.

The data storage device 124 can include one or more different types of data storage devices, such as, for example, one or more rotating disks drives, one or more solid state drives (SSDs), and/or any other type of data storage device. The data storage device 124 in some non-limiting examples includes a redundant array of independent disks (RAID) array. In other examples, the data storage device 124 includes a database.

The database can include any type of database for storing any type of data associated with managing digital tags. In some examples, the database includes a tag database storing tag data, a modular database storing modular (planogram) data, an aisle location database storing location data for modular displays and/or sections of a modular display within a retail environment, as well as any other type of database. The database can include a database on a physical data storage device as well as a cloud database.

The data storage device 124, in this example, is included within the computing device 102, attached to the computing device, plugged into the computing device, or otherwise associated with the computing device 102. In other examples, the data storage device 124 includes a remote data storage accessed by the computing device via the network 112, such as a remote data storage device, a data storage in a remote data center, or a cloud storage.

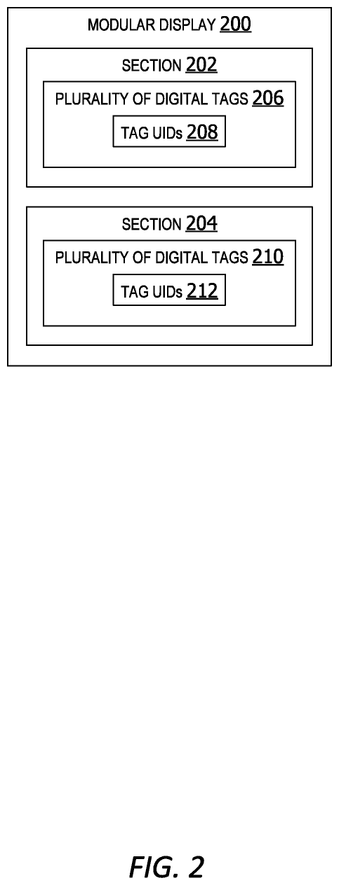

The memory 108 in some examples stores one or more computer-executable components, such as, but not limited to, a tag manager 140. The tag manager is a software component for linking digital tags with item data using image data and/or modular data 126. In some examples, the tag manager 140 receives image data 128 associated with one or more image(s) 139 of a portion of the modular display from an image capture device 138. The image(s) 139 include a plurality of tag UIDS 142 associated with a plurality of digital tags which are removably attached to the modular display, as shown in FIG. 2 below.

The tag manager, in this example, analyzes the image data 128 to identify a plurality of current tag locations of the plurality of digital tags on the modular display, such as, the assigned tag location 130. The assigned tag location 130 is identified based on image data including images of the tag UIDs displayed by the plurality of digital tags in the initial state. Each digital tag in the plurality of digital tags is associated with a current tag location on the modular display.

In other words, the image of the modular display includes the tag UID symbology displayed on each digital tag display screen. Each tag UID has a location on the modular display which is extrapolated by the tag manager using the image data. The current location of each physical digital tag on the modular display is compared with the assigned locations of the digital tags found in the modular data 126.

The symbology refers to the symbols used to depict and/or represent the UID. The symbology can include alphanumeric values representing a serial number. In other examples, the symbology can include the series of black and white markings representing barcodes and quick response (QR) codes. The tag UID in some examples includes symbology for identifying the digital tag, such as, but not limited to, a UPC code, barcode, serial number, etc. The tag UID in other examples is obtained via an RFID tag associated with each digital tag. The tag UID symbology in some examples is printed on an exterior of a housing of the digital tag. In other examples, the tag UID symbology is displayed via a display screen on the digital tag while the digital tag is in an initial or unlinked state.

The tag manager 140 attempts to match each digital tag current location(s) 144 with the assigned tag location(s). If a current tag location matches the assigned location for a digital tag, the tag is correlated with an assigned location. The correlated digital tags 146 are digital tags which have been placed in the expected location for the digital tag or within an acceptable threshold range of the assigned location.

If all the digital tag UIDs detected in the image data correlate to assigned tag locations, the plurality of digital tags are linked to item data for a plurality of items assigned to the modular display. In one example, if a first digital tag UID at a first current tag location matches an expected location of a digital tag, the tag is in the correct position on the modular display. A tag is in an expected location if the tag is at the assigned location or within an acceptable threshold range of the assigned location. If the number of tags 148 detected in the image data matches the expected number of tags 136 and all the digital tags detected in the image data are currently located in an expected location, the tag UIDs 142 for the detected tags are linked to the item(s) assigned to the modular display. The first digital tag is linked to the item for the item assigned to a display area corresponding to the assigned tag location 130 of the first digital tag. A second digital tag at a second current tag location is assigned to an item assigned to a display area corresponding to the second digital tag assigned location.

In some examples, a digital tag is linked to an item by pairing the tag UID for the digital tag with an item UID for the linked item in a data store, such as, but not limited to, the data storage device 124, a cloud storage or other remote data storage device.

In this example, a request 150 to populate the plurality of digital tags with item data associated with linked items is sent to an item management server, such as, but not limited to, the cloud server 118. The cloud server 118 transmits the item data 122 with instructions to populate all the digital tags on the portion of the modular display as a single batch request. Thus, in some examples, a single image of a portion of the modular display is used to link the digital tags and request all digital tags be populated without scanning the individual digital tags or scanning the items beings linked to the digital tags.

In other examples, if all the digital tag locations are correlated with assigned tag locations, the tag manager itself transmits item data to the linked digital tags triggering population of the digital tags with the linked item data.

If any detected digital tags do not match with an assigned tag location, the tag manager 140 generates customized instruction(s) 152 which are displayed to the user. The customized instruction(s) 152 include one or more instructions for correcting the misplaced, missing, or unneeded digital tags detected on the modular display via analysis of the image data 128. For example, if the expected number 132 of tags 136 is greater than the actual detected number of tags 148, the customized instructions 152 includes an instruction to place one or more additional digital tags in an initial (unlinked) state onto the modular display at the assigned tag locations which have not yet been matched to a digital tag due to a missing tag within the minimum threshold range of the assigned tag location.

In another example, if the expected number 132 of tags 136 exceeds the actual number of tags 148 detected on the modular display, the customized instruction includes directions for identifying and removing the excess or unneeded digital tags which have been placed on the modular display. In still other examples, if the expected number of tags 136 is equal to the detected number of tags 148, the customized instructions include directions for moving or adjusting the placement of one or more of the digital tags from the current tag location to the assigned tag location. In these examples, when the user or an autonomous robotic device has completed performance of the instructions, additional image data is obtained. The updated image data is analyzed to determine the updated locations of the digital tags. If the number of tags now equal the expected number of tags and the adjusted locations of the digital tags now fall within the threshold range of the assigned tag locations, the digital tags can be matched to the assigned items.

In other examples, the instructions for correcting placement of the digital tags is output to the user as a notification 154. The notification 154 includes a description of the problem with the current placement of the digital tags on the modular display, identification of the digital tags which are missing or placed in an incorrect location, and the instruction(s) 152 for correcting the tag placement. The notification 154 and/or instructions 152 are displayed to the user via a user interface, such as the user interface device 110. In other examples, the notification and/or instructions are transmitted to the user device 116 the network for display on the user interface 120.

In other examples, when the plurality of digital tags are linked with the plurality of items, the state of the plurality of digital tags is updated by the tag manager from the initial state to a linked state. In the initial state, the digital tags display UID symbology representing a UID for each tag. In the linked state, each digital tag is populated with item data describing an item linked to each digital tag.

The instruction(s) 152, in this example, are presented to the user via a user interface device 110 on the computing device 102. In other examples, the instruction(s) are presented to the user via the user interface 120 on the user device 116.

FIG. 2 is an exemplary block diagram illustrating a modular display 200 associated with a plurality of digital tags. In this non-limiting example, the modular display 200 includes two sections, a first section 202 and a second section 204. The first section 202 includes a first plurality of digital tags 206 removably attached to at least a portion of the modular display 200. Each digital tag in the plurality of digital tags is in an initial state in which the digital tag displays symbology representing the tag UID on the display of each tag. Thus, the first plurality of digital tags 206 display a first plurality of digital tag UIDs 208. The second plurality of digital tags 210 display a second plurality of tag UIDs 212 in the initial state.

In some examples, an image capture device captures an image of the plurality of tags 206 displaying the first plurality of tag UIDs 208 in a first image. The image capture device captures a second image of the second plurality of digital tags 210 displaying the second plurality of tag UIDs 212. The tag manager analyzes the tag data to identify each digital tag using the tag UID displayed by each tag. The tag manager determines the current location of each digital tag based on the location of the digital tag relative to one or more other elements of the modular display visible in the first image of the first section of the display.

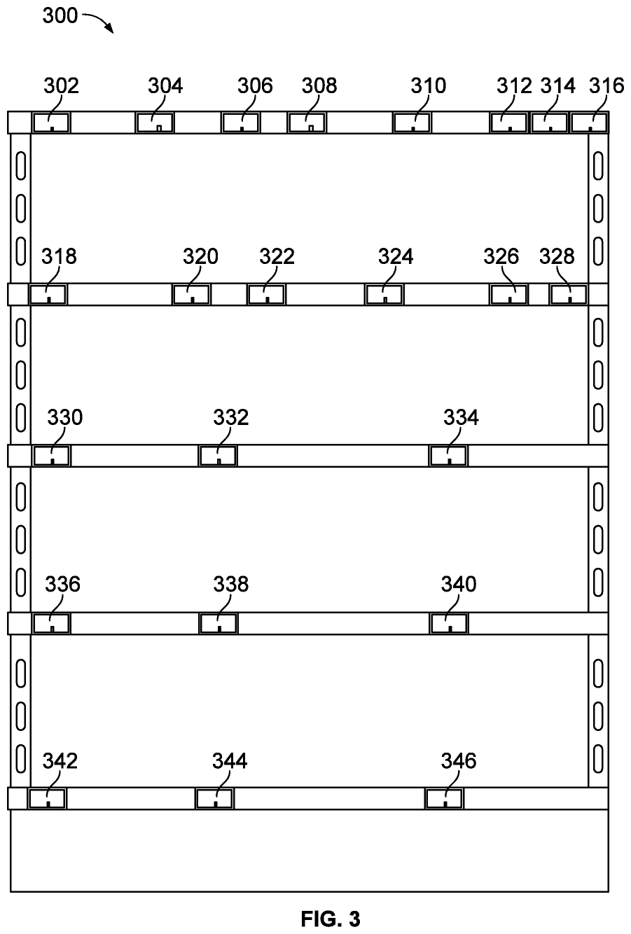

FIG. 3 is an exemplary block diagram illustrating a modular display 300 including a set of digital tags removably attached to the modular display 300. The modular display 300 in this example is a set of shelves. However, the examples are not limited to a shelf or a set of shelves. In other examples, the modular display 300 is implemented as a gondola shelving unit, a bin, a rack, a display counter, a temperature-controlled display unit, or any other type of modular display.

In this example, the modular display has a set of twenty-three digital tags placed on the modular display at twenty-three different locations on the modular display, such as, but not limited to, the digital tag. However, the examples are not limited to a set of twenty-three digital tags. In other examples, the set of digital tags includes any number of digital tags.

The modular data in some examples specifies the number of digital tags and the sequence in which the digital tags should be placed on the modular display. The digital tags are captured in an image of the portion of the modular display all at once. In this example, all the tags on the top shelf include digital tag 302, digital tag 304, digital tag 306, digital tag 308, digital tag 310, digital tag 312, digital tag 314 and digital tag 316. The digital tags on the second shelf from the top include digital tag 318, digital tag 320, digital tag 322, digital tag 324, digital tag 326 and digital tag 328. The digital tags on the third shelf include the digital tag 330, the digital tag 332 and the digital tag 334. The tags on the fourth shelf include digital tag 336, digital tag 338 and/or the digital tag 340 is scanned last. In this example, the bottom shelf includes digital tag 342, digital tag 344 and digital tag 346. All the digital tag UIDs and current tag locations are captured within a single image. In other examples, two or more images may be used to capture all the digital tags on the modular.

If all tags are present in the correct number and expected location, the digital tags are linked to the items associated with each assigned location on the modular display.

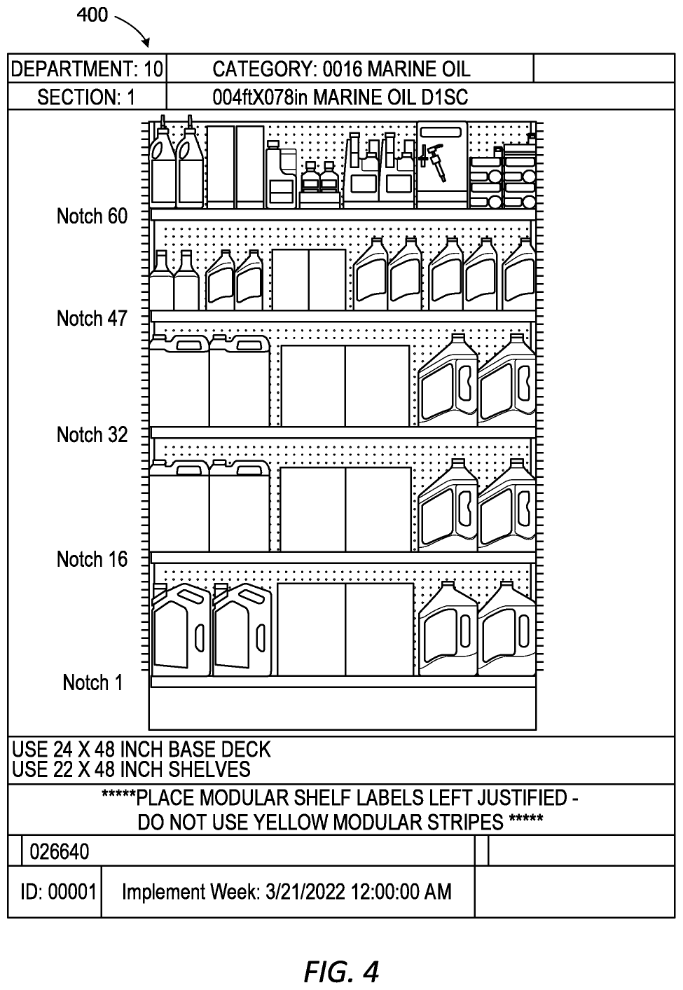

FIG. 4 is an exemplary block diagram illustrating a planogram 400 associated with a modular display including a set of items assigned to be displayed on the modular display and expected digital tag locations, such as, but not limited to, the modular display 200 in FIG. 2 above. The modular data obtained from the planogram is utilized by the tag manager to determine whether digital tags are correctly placed on the modular display and link tag to items. The planogram identifies a plurality of items assigned to a modular display and specifies a display area or location on the modular display where instances of each assigned item should be placed when the items are stocked on the shelf. The digital tags are placed on the modular display such that at least one digital tag is located within a proximity or threshold range of the display area of each assigned item.

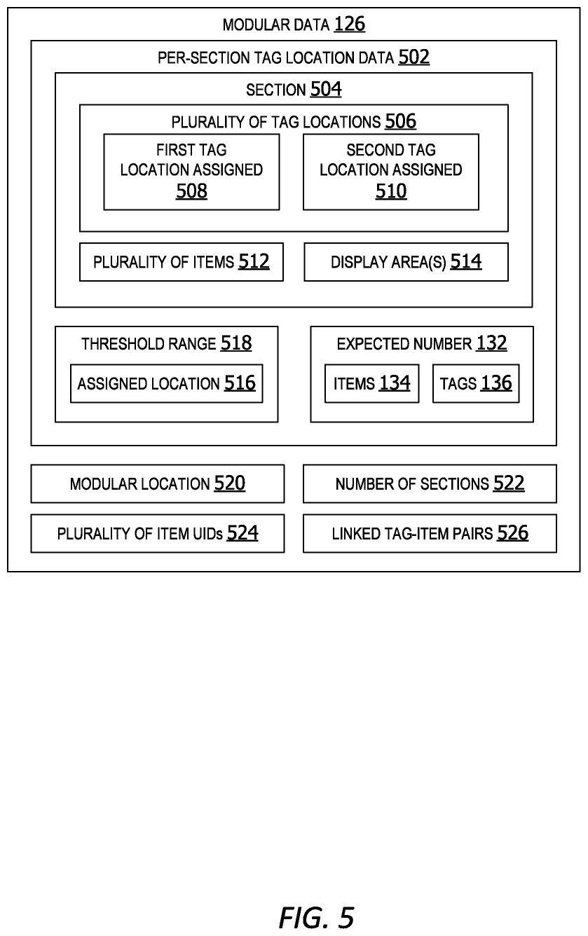

FIG. 5 is an exemplary block diagram illustrating modular data 126 associated with a portion of a modular display, such as, but not limited to, the modular display 200. The modular data include per-section tag location data 502. The per-section tag location data 502 includes data describing the assigned location of digital tags placed on the section 504 of the modular display. The section 504 is a portion of the modular display. The section 504 of the modular display can include any portion of the modular display. In this example, the section 504 of the modular display includes a four-foot (4 ft) section of the display.

The section 504 includes a plurality of tag locations 506, such as a first assigned tag location 508 and a second assigned tag location 510. Each digital tag in a plurality of digital tags is assigned to an assigned location on the modular display, such as, but not limited to, the first assigned tag location 508 and/or the second assigned tag location 510. The examples are not limited to two assigned tag locations. In other examples, the plurality of tag locations 506 includes three or more assigned tag locations.

A plurality of items 512 are assigned to be displayed on the modular display. Each item in the plurality of items 512 is a different type of item. Each type of item in the plurality of items 512 is assigned to a display area in a plurality of display area(s) 514 on the section of the modular display. A display area is a display space or area in which instances of the assigned item can be placed for display on the modular display.

Each digital tag should be placed at the assigned location 516 or within a threshold range 518 of the assigned location. The threshold range 518 is a range or area surrounding the assigned location 516. In some examples, the threshold range 518 is a distance from the assigned location 516. For example, the threshold range 518 can include a two-inch distance from the assigned location. In this example, if the digital tag is placed within two inches of the assigned location on either side, the digital tag is placed correctly within the expected location for the digital tag. However, if no digital tag is detected within the two-inch distance of the assigned location, then no digital tag correlates with the assigned location 516.

In other examples, the modular data 126 includes an expected number 132 of items 134 and/or an expected number 132 of digital tags 136. If the total number of digital tags detected in the image data of the section of the modular data is less than the expected number of tags 136, there are not enough digital tags placed on the modular. If the number of detected tags is greater than the expected number of tags 136, there are too many digital tags placed on the section 504 of the modular data 126.

The modular data 126, in other examples, includes modular location 520 of the section 504 of the modular display. The user scans an aisle location identifier on the physical modular display when the user begins setting the modular. The tag manager identifies the section 504 of the modular display by comparing the scanned aisle identifier with the modular location 520 data for the plurality of modulars and modular sections.

In other examples, the modular data 126 includes a number of sections 522 within the modular display. The modular display can include a single section, as well as two or more sections. In one non-limiting example, the modular display includes four sections. In other non-limiting examples, the modular display includes five sections.

The modular data, in still other examples, includes a plurality of item UIDs 524 for the plurality of different items or types of items assigned to the modular display section 504. The plurality of item UIDs 524 includes at least one UID for each item.

In still yet other examples, the modular data 126 includes linked tag-item pairs 526. The linked tag-item pairs 526 includes an identification of each digital tag in the plurality of digital tags assigned to the modular display with an item in the plurality of items assigned to the section 504 of the modular display. In some examples, each digital tag UID is paired with an item UID.

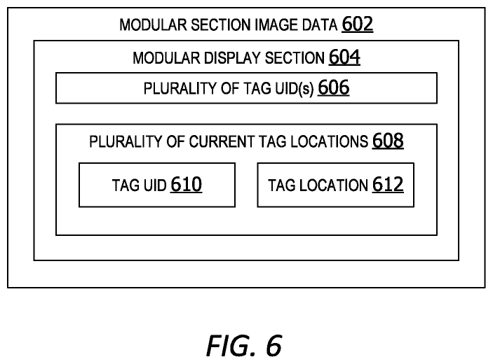

FIG. 6 is an exemplary block diagram illustrating image data associated with a portion of a modular display. In this example, the modular section image data 602 is image data associated with an image of a portion of the modular display, such as, but not limited to, a modular display section 604. The modular section image data 602 is generated by an image capture device, such as, but not limited to, the image capture device 138. In some examples, the modular display section includes a plurality of tag UID(s) 606 associated with a plurality of digital tags and/or a plurality of current tag locations 608.

The plurality of tag UID(s) 606 includes each UID displayed by a tag display screen on each digital tag. The plurality of tag UID(s) 606 are detected within the image of the modular display. In other examples, the tag UID(s) are printed on a digital tag housing. Thus, the tag manager identifies the UID based on an image of the digital tag housing or the digital tag display screen. The tag display screen is any type of display screen. In some examples, the tag display screen is an LED display screen.

The plurality of current tag locations 608 includes a tag UID 610 for each tag location 612 of each digital tag placed on the modular display. The tag location 612 is a location on the modular display. The tag location 612 is extrapolated by the tag manager based on notches or other landmarks on the modular display which are detectable within the image. In still other examples, the tag location is predicted by the tag manager based on the distance between each digital tag.

FIG. 7 is an exemplary flow chart 700 illustrating operation of the computing device to generate alert notifications associated with placement of digital tags on a portion of a modular display. The process shown in FIG. 7 is performed by a tag manager, executing on a computing device, such as the computing device 102 in FIG. 1 or the user device 116 in FIG. 1.

The process begins by selecting a modular to set from a plurality of modular displays at 702. Setting a modular display refers to placing the digital tags, populating the digital tags with item data and/or stocking the modular display with items described by the item data displayed by the digital tags on the modular display.

The tag manager obtains image data at 704. In some examples, the tag manager obtains the image data from a camera or other image capture device, such as, but not limited to, the image capture device 138 in FIG. 1. The tag manager captures symbology on the plurality of digital tags at 706. The tag manager matches the digital tags to the assigned tag locations at 708. The tag manager determines whether the digital tag's current locations match the assigned locations at 710. If yes, the tag manager populates the plurality of digital tags with item data for the items associated with each assigned tag location at 712. In other examples, the tag manager sends a batch request for a remote server to populate the digital tags with the item data.

If the current location of all the digital tags does not match the assigned locations, the tag manager generates an alert notification with instructions at 714. The instructions include customized instructions to add digital tag(s), remove digital tag(s) and/or change the placement of one or more of the digital tag(s). The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart 800 illustrating operation of the computing device to generate customized instructions for correcting erroneous tag placements on a modular display. The process shown in FIG. 8 is performed by a tag manager, executing on a computing device, such as the computing device 102 in FIG. 1 or the user device 116 in FIG. 1.

The process begins by obtaining an image of a modular display at 802. The tag manager identifies current tag locations at 804. The current tag locations are identified based on the locations of the digital tags detected in the obtained image. The tag manager correlates current tag locations with assigned tag locations at 806. The tag manager determines whether the current tag locations match the assigned tag locations at 808. If yes, the tag manager links the tags to the items at 812. However, if the current tag locations do not match the assigned tag locations, the tag manager determines whether the current tag locations are within a threshold range of the assigned tag locations at 810. If yes, the tag manager links the digital tags to the items at 812.

Returning to 810, if the current location of the digital tags is not within range of the assigned location, the tag manager generates customized instructions to correct tag placement at 814. The tag manager presents the instructions to the user via the user interface at 816. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an exemplary flow chart 900 illustrating operation of the computing device to link digital tags with items assigned to a modular display using image data. The process shown in FIG. 9 is performed by a tag manager, executing on a computing device, such as the computing device 102 in FIG. 1 or the user device 116 in FIG. 1.

The process begins by the generating one or more image(s) of the modular display at 902. The tag manager identifies the tag locations on the modular display using the image(s) at 904. The tag manager determines whether an expected number of digital tags are detected on the modular display at 906. If yes, the tag manager identifies a current location of each digital tag at 908. The tag manager determines whether the digital tag locations match expected locations for the digital tags at 910. If not, the tag manager generates a notification at 912. The notification alerts the user that one or more digital tags is not detected within an expected location on the modular display. The notification optionally includes customized instructions directing the user to change the location(s) of one or more digital tags.

If the digital tags are all located in expected locations on the modular display, the tag manager links the digital tags to items assigned to the modular display at 914. The tag manager sends a request to populate the tags at 916. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an exemplary flow chart 1000 illustrating operation of the computing device to display customized instructions to users associated with changing a location of digital tags to correlate with expected digital tag locations. The process shown in FIG. 10 is performed by a tag manager, executing on a computing device, such as the computing device 102 in FIG. 1 or the user device 116 in FIG. 1.

The process begins by comparing the number of detected tags with the expected number of digital tags at 1002. The tag manager determines whether the detected number of digital tags matches the expected number of digital tags at 1004. If yes, the tag manager generates instructions to move the digital(s) which are outside the threshold range of an assigned location at 1006. The tag manager displays the instruction(s) to the user via a UI at 1014. The process terminates thereafter.

If the detected number of digital tags does not match the expected number of digital tags, the tag manager determines whether the detected number of tags is too few as compared with the expected number of digital tags (less than the expected number) at 1008. If the detected number is not less than the expected number, the tag manager generates a customized instruction directing the user to remove one or more excess digital tag(s) at 1010. The tag manager displays the instruction(s) to the user via a UI at 1014. The process terminates thereafter.

If the detected number of digital tags is less than the expected number of digital tags, the tag manager generates an instruction directing the user to add one or more digital tags to the modular display at 1012. The tag manager displays the instruction(s) to the user via a UI at 1014. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

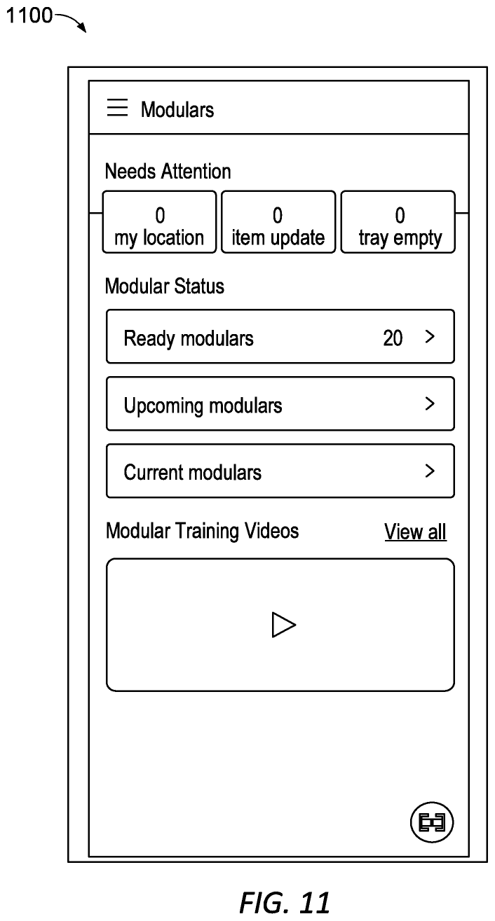

FIG. 11 is an exemplary diagram illustrating a user interface (UI) 1100 displaying an initial status page for setting a modular having a plurality of sections. In this example, the display provides information regarding the number of modulars ready to be set with digital tags. In this example, the number of ready modulars is twenty. However, the examples are not limited to twenty modulars. The number of modulars ready to be set with digital tags can be any number of modular displays. The system optionally provides modular training videos to assist the user in setting the digital tags.

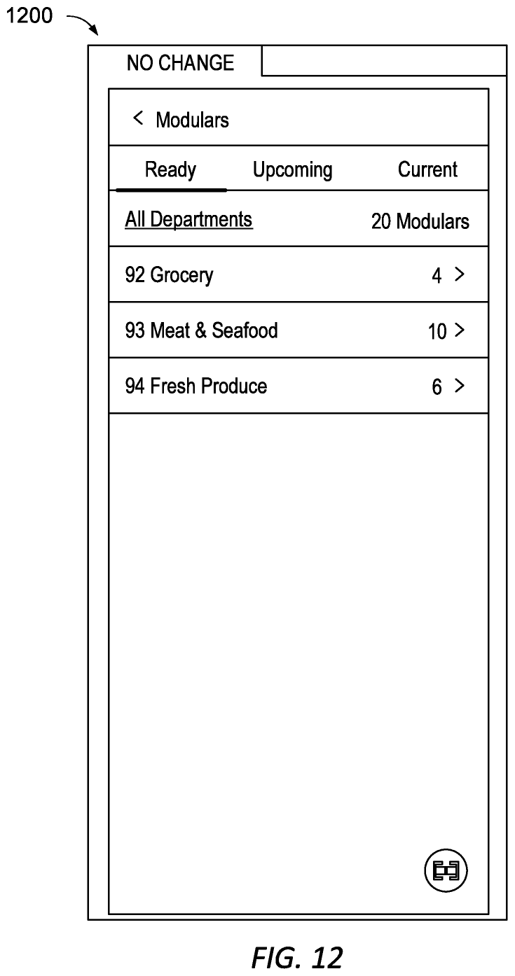

FIG. 12 is an exemplary diagram illustrating a UI 1200 displaying a plurality of departments including a plurality of modular displays. In this example, the display indicates that there are twenty modulars across all the listed departments. The grocery department includes four modulars that are ready to be set. However, the examples are not limited to four modulars in a grocery department. In other examples, any number of modulars may be available to be set in any type of department.

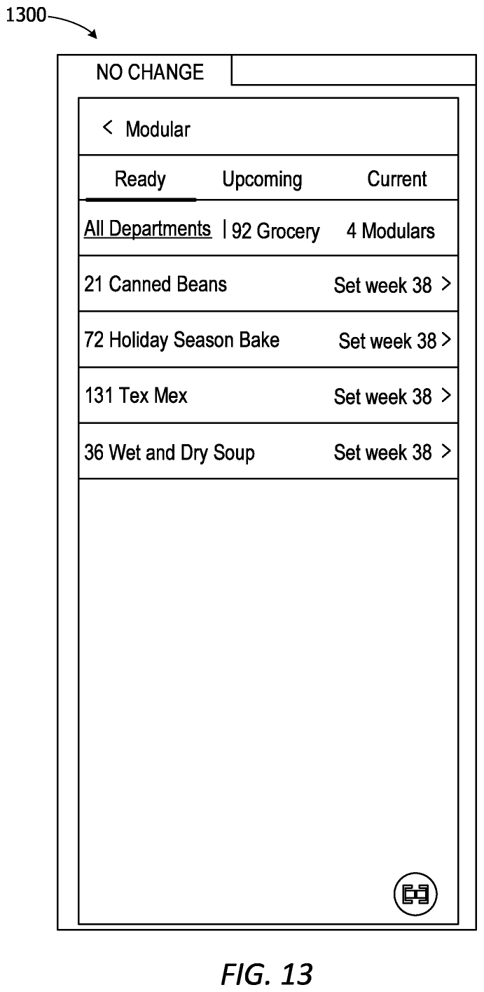

FIG. 13 is an exemplary diagram illustrating a UI 1300 displaying a plurality of items assigned to a plurality of modular displays associated with a given department in a retail environment. The display in this example identifies each of the four modulars that are ready to be set in the grocery department.

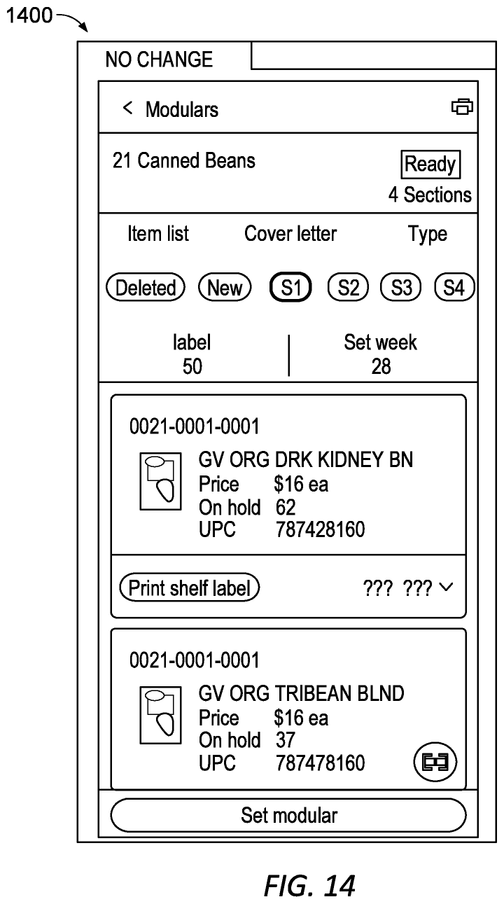

FIG. 14 is an exemplary diagram illustrating a UI 1400 displaying a plurality of items assigned to a set of modular displays in a retail environment. The display, in this example, includes four sections. The display indicates that the first section on the modular is ready to be set.

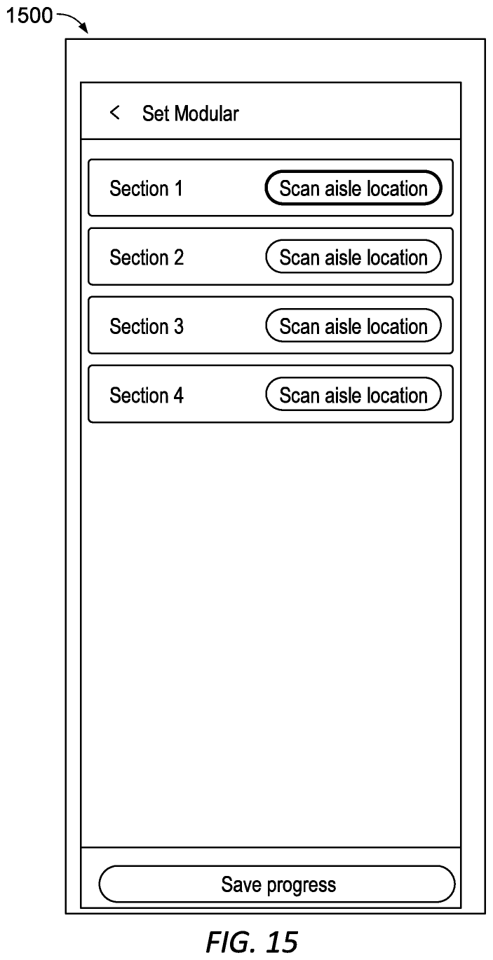

FIG. 15 is an exemplary diagram illustrating a UI 1500 displaying a landing page for setting a section of a modular display in a plurality of modular displays ready to be set. In this example, the display indicates that the user should scan an aisle location identifying the first section of the modular prior to taking an image of the modular display.

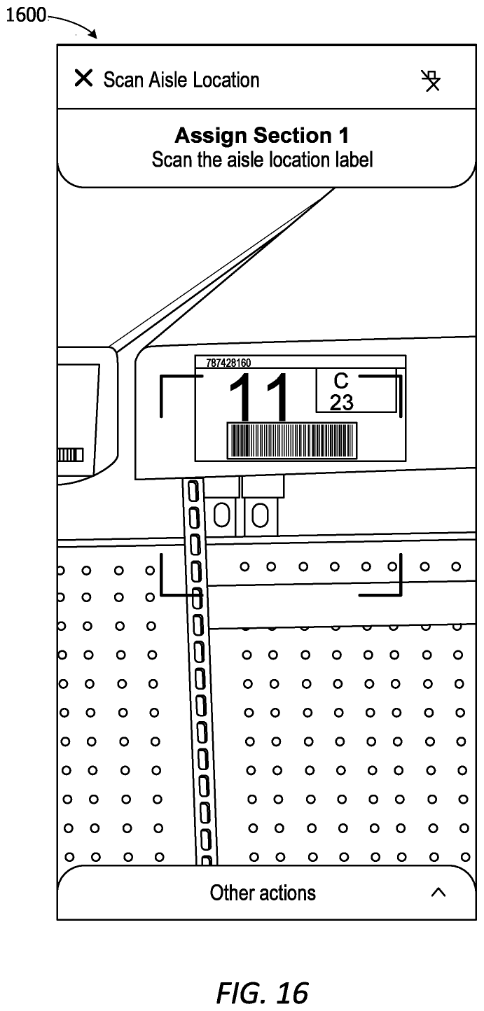

FIG. 16 is an exemplary diagram illustrating a UI 1600 displaying a scan aisle location instruction for setting digital tags on the portion of the modular display associated with the aisle location. The user captures an image of the aisle location UID. The tag manager uses the aisle location UID to identify the plurality of digital tags assigned locations in the modular data used to link the digital tags with items assigned to the modular display. Items are assigned to the modular display if the items are currently stocked on the display or if the items are to be stocked on the modular display.

### Additional Examples

In some examples, the tag manager presents a landing page to a user via a UI when the user is ready to set a modular with digital tags. The tag manager receives a user selection of a department and user selection of a category. The user selects an option to “set a modular.” The user utilizes the UI to select an “assign” section feature. The tag manager instructs the user to capture an image of an aisle location label and/or scan the aisle location label. The tag manager receives image data captured by an image capture device (camera) on the user device or another remote image capture device which transmits the image data to the tag manager via a network. The tag manager correlates the digital tags in the image data with modular data for the selected modular. The tag manager highlights possible tag placement errors for digital tags which do not correlate with an expected tag location in a set of instructions. The expected tag location includes an area within a threshold range of an assigned tag location. After the associate follows the output instructions to correct the errors. When finished, the tag manager displays a summary indicating which sections of the modular are complete and which sections of the modular are ready to be set. When all sections are confirmed complete, setting the entire modular display is complete.

In an example scenario, the tag manager receives a user selection to set a modular display or a section of a modular display from a plurality of available modular displays. In some examples, the plurality of available modular displays are provided in a list of modular displays which are ready to be set. In some examples, a user places a plurality of digital tags on the selected modular display in the approximate locations in accordance with a planogram (modular data) specifying the assigned locations for each digital tag. In other examples, a robotic device places the digital tags on the modular display. Once the tags are set in place, the tag manager generates an instruction to capture an image of the modular display. The tag manager receives the image data, including the captured symbology on the plurality of digital tags. The tag manager attempts to correlate the detected digital tags with the expected tag locations. If all the digital tags match, the tags are linked to items/item data and populated with the item data. If the digital tags do not all match, the tag manager prompts the user in the tag manager application to adjust the placement of the tags, remove unneeded (extra) digital tags and/or add additional digital tags, as needed to match the expected number of digital tags.

In other examples, the system attempts to correlate the current location of each digital tag placed on the modular display with an assigned tag location. If a portion of the tags are correlated, the system links the correlated digital tags with a corresponding item or type of item assigned to that location. The portion of the digital tags can include all of the digital tags (100% of the digital tags) or a sub-set of the digital tags (less than 100% of the digital tags). If a portion of the tags (one or more) are not correlated with an assigned location, this indicates that the uncorrelated tags which fail to map to an assigned location are either in the wrong location on the modular or an incorrect number of digital tags have been placed on the modular display. Customized instructions are generated which include one or more instructions for correcting the digital tag placements on the modular display. The instructions can include a recommendation to move a digital tag to a different position on the modular display, add one or more additional digital tags to the modular display or remove extra digital tag(s) from the modular display.

Alternatively, or in addition to the other examples described herein, examples include any combination of the following:
detect a digital tag unique identifier (UID) associated with a selected digital tag having a current tag location failing to correlate with an assigned tag location;
determine whether a number of detected digital tags within the image of the portion of the modular matches an expected number of items;
responsive to the number of detected digital tags equaling the expected number of items, generate an instruction to move the selected digital tag within a minimum threshold range of an assigned tag location which is unmatched with a current location of any digital tag in the plurality of digital tags;
responsive to the number of detected digital tags falling below the expected number of items, generate an instruction to add a digital tag to the portion of the modular display within the minimum threshold range of the assigned tag location;
responsive to the number of detected digital tags exceeding the expected number of items, generating an instruction to remove the selected digital tag;
a robotic device generating the image of the portion of the modular display;
the robotic device including an image capture device;
an image capture device mounted to a robotic device;
the robotic device providing one or more images of one or more portions of the modular display;
the image of the portion of the modular display including one or more images of one or more digital tag UIDs visible within the one or more images;
send a batch instruction to populate the plurality of digital tags on the portion of the modular display in response to linking the plurality of digital tags with the plurality of items;
update a state of the plurality of digital tags linked to the plurality of items from an initial state to a linked state, wherein a digital tag in an initial state displays a tag UID symbology on a display of the digital tag, and wherein the digital tag displays the item data on the display of the digital tag in the linked state;
receiving image data associated with an image of a portion of the modular display from an image capture device, the image comprising a plurality of tag UIDS associated with a plurality of digital tags associated with the portion of the modular display;
identifying a plurality of current tag locations of the plurality of digital tags on the modular display from the image using the plurality of tag UIDs in the image data, wherein each digital tag in the plurality of digital tags is associated with a current tag location on the modular display;
determining whether the plurality of current tag locations of the plurality of digital tags correlates with a plurality of assigned tag locations associated with the modular display, wherein an assigned tag location is associated with each item in a plurality of items assigned to the portion of the modular display;
mapping the plurality of current tag location to a plurality of assigned tag locations;
linking a portion of the plurality of digital tags to a plurality of item UIDs associated with a plurality of items assigned to the portion of the modular display in response to every current tag location in the plurality of current tag locations correlating with an assigned tag location in the plurality of assigned tag locations;
generating a customized instruction for changing a current location of at least one digital tag in the plurality of digital tags on the portion of the modular display in response to a failure to correlate every current tag location in the plurality of current tag locations with an assigned tag location in the plurality of assigned tag locations;
sending a batch request to populate all the digital tags in the plurality of digital tags with item data associated with each item linked to each digital tag;
updating a state of the plurality of digital tags from an initial state to a linked state in response to linking the plurality of digital tags with the plurality of items, wherein the digital tag in the linked state displays item information for an item linked to the digital tag;
detect a digital tag UID associated with a selected digital tag having a current tag location failing to correlate with an assigned tag location;
determine whether a number of detected digital tags within the image of the portion of the modular matches an expected number of items;
responsive to the number of detected digital tags equaling the expected number of items, generating an instruction to move the selected digital tag within a minimum threshold range of an assigned tag location which is unmatched with a current location of any digital tag in the plurality of digital tags;
responsive to the number of detected digital tags falling below the expected number of items, generating an instruction to add a digital tag to the portion of the modular display within the minimum threshold range of the assigned tag location;
responsive to the number of detected digital tags falling below the expected number of items, generating an instruction to add a digital tag to the portion of the modular display within the minimum threshold range of the assigned tag location; and
in response to the number of detected digital tags exceeding the expected number of items, generating an instruction to remove the selected digital tag.

At least a portion of the functionality of the various elements in FIG. 1, FIG. 2, FIG. 3, FIG. 4, FIG. 5, and FIG. 6 can be performed by other elements in FIG. 1, FIG. 2, FIG. 3, FIG. 4, FIG. 5 and FIG. 6, or an entity (e.g., processor 106, web service, server, application program, computing device, etc.) not shown in FIG. 1, FIG. 2, FIG. 3, FIG. 4, FIG. 5, and FIG. 6.

In some examples, the operations illustrated in FIG. 7, FIG. 8, FIG. 9, and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of linking digital tags using modular data, the method comprising receiving image data associated with an image of a portion of the modular display from an image capture device, the image comprising a plurality of tag UIDS associated with a plurality of digital tags associated with the portion of the modular display; identifying a plurality of current tag locations of the plurality of digital tags on the modular display from the image using the plurality of tag UIDs in the image data; determining whether the plurality of current tag locations of the plurality of digital tags correlates with a plurality of assigned tag locations associated with the modular display, wherein an assigned tag location is associated with each item in a plurality of items assigned to the portion of the modular display; linking the plurality of digital tags to a plurality of item UIDs associated with a plurality of items assigned to the portion of the modular display in response to every current tag location in the plurality of current tag locations correlating with an assigned tag location in the plurality of assigned tag locations; and generating a customized instruction for changing a current location of at least one digital tag in the plurality of digital tags on the portion of the modular display in response to a failure to correlate every current tag location in the plurality of current tag locations with an assigned tag location in the plurality of assigned tag locations.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for linking digital tags. For example, the elements illustrated in FIG. 1, FIG. 2, FIG. 3, FIG. 4, FIG. 5 and FIG. 6, such as when encoded to perform the operations illustrated in FIG. 7, FIG. 8, FIG. 9, and FIG. 10, constitute exemplary means for identifying a plurality of current tag locations of the plurality of digital tags on a portion of a modular display from image data associated with an image of a portion of the modular display, the image comprising a plurality of tag UIDS associated with the plurality of digital tags, exemplary means for correlating each tag location in the plurality of current tag locations with each assigned tag location in a plurality of assigned tag locations associated with modular data associated with the portion of the modular display to form a set of correlated digital tags, and exemplary means for generate a customized instruction to alter a location of each digital tag in the plurality of digital tags failing to correlate with the plurality of assigned tag locations, wherein the customized instruction is presented to a user via a user interface device.

Other non-limiting examples provide one or more computer storage devices having a first computer-executable instructions stored thereon for linking digital tags to items on a modular display. When executed by a computer, the computer performs operations including obtaining an image of the portion of the modular display, the image comprising a plurality of tag UIDS associated with the plurality of digital tags; identifying a plurality of current tag locations of the plurality of digital tags on the modular display from the image; determining whether the plurality of current tag locations of the plurality of digital tags correlate with a plurality of assigned tag locations in modular data associated with the modular display; linking the plurality of digital tags with a plurality of items assigned to the modular display in response to the plurality of current tag locations correlating with the plurality of assigned tag locations, wherein a digital tag linked to a selected item is populated with item data describing the selected item; and generating a customized instruction to alter a location of at least one digital tag in the plurality of digital tags in response to the plurality of current tag locations failing to correlate with the plurality of assigned tag locations.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for linking digital tags using modular data, the system comprising:
a plurality of digital tags attached to a portion of a modular display, the plurality of digital tags displaying a tag unique identifier (UID); and
a computer-readable medium storing instructions that are operative upon execution by a processor to:
obtain an image of the portion of the modular display, the image comprising a plurality of tag UIDs, the plurality of tag UIDs comprising the tag UID displayed by each digital tag in the plurality of digital tags;
identify a plurality of current tag locations of the plurality of digital tags on the modular display using the plurality of tag UIDs in the image;
determine whether the plurality of current tag locations of the plurality of digital tags correlate with a plurality of assigned tag locations in modular data associated with the modular display; and
in response to a portion of the plurality of current tag locations correlating with the plurality of assigned tag locations, link the portion of the plurality of digital tags with a plurality of items assigned to the modular display wherein a digital tag linked to a selected item is populated with item data describing the selected item.

2. The system of claim 1, wherein the portion of the current tag locations is a first portion of the plurality of current tag locations, and wherein the instructions are further operative to:
in response to a second portion of the plurality of current tag locations failing to correlate with the plurality of assigned tag locations, generate a customized instruction to alter a location of at least one digital tag in the portion of the plurality of digital tags.

3. The system of claim 1, wherein the instructions are further operative to:
detect a digital tag UID associated with a selected digital tag having a current tag location failing to correlate with an assigned tag location;
determine whether a number of detected digital tags within the image of the portion of the modular display matches an expected number of different types of items in the modular data; and
responsive to the number of detected digital tags equaling the expected number of different types of items, generate an instruction to move the selected digital tag within a minimum threshold range of an assigned tag location which is unmatched with a current location of any digital tag in the plurality of digital tags.

4. The system of claim 3, wherein the instructions are further operative to:
responsive to the number of detected digital tags falling below the expected number of different types of items, generate an instruction to add an additional digital tag to the portion of the modular display within the minimum threshold range of the assigned tag location; and
responsive to the number of detected digital tags exceeding the expected number of different types of items, generating a customized instruction to remove at least one digital tag in the plurality of digital tags from the portion of the modular display.

5. The system of claim 1, further comprising:
a robotic device providing the image of the portion of the modular display.

6. The system of claim 1, wherein the instructions are further operative to:
send a batch instruction to populate the plurality of digital tags on the portion of the modular display with the item data in response to linking the plurality of digital tags with the plurality of items, wherein populating the plurality of digital tags comprises instructing each digital tag in the plurality of digital tags to display the item data associated with at least one type of item on a tag display of each digital tag.

7. The system of claim 1, wherein the instructions are further operative to:
update a state of the plurality of digital tags linked to the plurality of items from an initial state to a linked state, wherein a selected digital tag in the initial state displays a tag UID symbology on a tag display of the selected digital tag, and wherein the selected digital tag displays the item data on the tag display of the selected digital tag in the linked state.

8. A method for linking digital tags, the method comprising:
receiving image data associated with an image of a portion of a modular display from an image capture device, the image comprising a plurality of tag UIDS associated with a plurality of digital tags associated with the portion of the modular display;
identifying a plurality of current tag locations of the plurality of digital tags on the modular display from the image using the plurality of tag UIDs in the image data, wherein each digital tag in the plurality of digital tags is associated with a current tag location on the modular display;
correlating the plurality of current tag locations of the plurality of digital tags correlates with a plurality of assigned tag locations associated with the modular display, wherein an assigned tag location is associated with each type of item in a plurality of items assigned to the portion of the modular display;
linking the plurality of digital tags to a plurality of item UIDs associated with the plurality of items assigned to the portion of the modular display in response to every current tag location in the plurality of current tag locations correlating with the assigned tag location in the plurality of assigned tag locations, wherein each linked digital tag in the plurality of digital tags is populated with item data describing an item associated with an item UID in the plurality of item UIDs; and
generating a customized instruction for changing a current location of at least one digital tag in the plurality of digital tags on the portion of the modular display in response to a failure to correlate every current tag location in the plurality of current tag locations with the assigned tag location in the plurality of assigned tag locations, wherein the customized instruction is presented to a user via a user interface device.

9. The method of claim 8, further comprising:
sending a batch request to populate all the digital tags in the plurality of digital tags with the item data associated with each item linked to each digital tag.

10. The method of claim 8, further comprising:
updating a state of the plurality of digital tags from an initial state to a linked state in response to linking the plurality of digital tags with the plurality of items, wherein a selected digital tag in the linked state displays item information for an item type linked to the digital tag, and wherein the digital tag in the initial state displays tag UID symbology.

11. The method of claim 8, further comprising:
detecting a digital tag UID associated with a selected digital tag having a current tag location failing to correlate with the assigned tag location;
comparing a number of detected digital tags within the image of the portion of the modular display with an expected number of items; and
responsive to the number of detected digital tags equaling the expected number of items, generating an instruction to move the selected digital tag within a minimum threshold range of an assigned tag location which is unmatched with the current location of any digital tag in the plurality of digital tags.

12. The method of claim 11, further comprising:
responsive to the number of detected digital tags falling below the expected number of items, generating the instruction to add a digital tag to the portion of the modular display within the minimum threshold range of the assigned tag location.

13. The method of claim 11, further comprising:
responsive to the number of detected digital tags exceeding the expected number of items, generating the instruction to remove the selected digital tag.

14. The method of claim 8, further comprising:
generating the image via a robotic device, wherein the robotic device transmits the image to a tag manager via a network.

15. One or more computer storage devices having computer-executable instructions stored thereon, which, upon execution by a computer, cause the computer to perform operations comprising:
identify a plurality of current tag locations of a plurality of digital tags on a portion of a modular display from image data associated with an image of the portion of the modular display, the image comprising a plurality of tag UIDS displayed by the plurality of digital tags;
correlate each tag location in the plurality of current tag locations with each assigned tag location in a plurality of assigned tag locations associated with modular data associated with the portion of the modular display to form a set of correlated digital tags;
link a set of tag UIDs from the plurality of tag UIDs associated with the set of correlated digital tags with a set of item UIDs associated with a plurality of types of items assigned to the modular display, wherein a digital tag in the set of correlated digital tags linked to an item UID is populated with item data describing an item type associated with the item UID linked to the digital tag; and
generate a customized instruction to alter a location of each digital tag in the plurality of digital tags failing to correlate with the plurality of assigned tag locations, wherein the customized instruction is presented to a user via a user interface device.

16. The one or more computer storage devices of claim 15, wherein the operations further comprise:
detect a digital tag UID associated with a selected digital tag having a current tag location failing to correlate with an assigned tag location;
determine whether a number of detected digital tags within the image of the portion of the modular display matches an expected number of item types; and
responsive to the number of detected digital tags equaling the expected number of item types, generating an instruction to move the selected digital tag within a minimum threshold range of an assigned tag location which is unmatched with a current location of any digital tag in the plurality of digital tags.

17. The one or more computer storage devices of claim 16, wherein the operations further comprise:
responsive to the number of detected digital tags falling below the expected number of items, generate the instruction, including a customized instruction to add at least one digital tag to the portion of the modular display within a minimum threshold range of the assigned tag location.

18. The one or more computer storage devices of claim 16, wherein the operations further comprise:
responsive to the number of detected digital tags exceeding the expected number of items, generate the instruction, including a customized instruction to remove the selected digital tag.

19. The one or more computer storage devices of claim 15, wherein the operations further comprise:
receive image data associated with the modular display from a robotic device comprising an image capture device that generates the image data.

20. The one or more computer storage devices of claim 15, wherein the operations further comprise:
update a state of the plurality of digital tags linked to a plurality of items from an initial state to a linked state, wherein a selected digital tag in the initial state displays a tag UID symbology on a tag display of the selected digital tag, and wherein the selected digital tag displays the item data on the tag display of the selected digital tag in the linked state.
